(19) United States
(12) Patent Application Publication
(10) Pub. No.: US 2016/0264840 A1
(43) Pub. Date: Sep. 15, 2016

(54) CEMENT SLURRY COMPOSITIONS, METHODS OF MAKING AND METHODS OF USE

(71) Applicant: Scott Gregory Nelson, Cypress, TX (US)

(72) Inventor: Scott Gregory Nelson, Cypress, TX (US)

(73) Assignee: BAKER HUGHES INCORPORATED, Houston, TX (US)

(21) Appl. No.: 14/643,167

(22) Filed: Mar. 10, 2015

(51) Int. Cl. C09K 8/487; C09K 8/42; E21B 33/138

(52) U.S. Cl. CPC C09K 8/487; E21B 33/138; C09K 8/426

(57) ABSTRACT

A cement slurry for use in a wellbore during wellbore cementing includes an aqueous cement slurry and a preformed synthetic polymer swellable in the aqueous cement slurry.

### BACKGROUND

This disclosure relates to preformed synthetic polymers for use in wellbores, methods for their manufacture, and methods of use comprising at least one of the foregoing.

Plugging oil or gas wells with a cement plug is a common operation in the art. In general, the goal of plug cementing is to secure a stable and effective seal in a designated location of the wellbore, generally not at the bottom of the wellbore. The cement is accordingly placed in the desired location in the well in the form of a slurry, which then sets to form a cement plug. Placing a relatively small amount of cement slurry above a larger volume of a drilling fluid requires consideration of design factors such as the density and rheology of both the cement and the drilling fluid, hole size, and hole angle, including vertical, deviated and horizontal well orientations.

Placement and setting of cement plugs in the wellbore, particularly gelation and hydration processes that set up a cement slurry, can be disturbed by a number of factors. For example, the cement particles in a cement slurry can segregate to an unacceptable degree, such that the resulting plug is prone to structural failure under the high annular pressures as they exist in drill holes. Further, some aqueous cement slurries, when the water present in the slurry is not bound effectively during hydration of cement, generate free water during settling. This phenomenon is also known as dehydrating cement. Unbound water rises through the cement, which disturbs cement settling and hardening. This feature is unacceptable in the art, especially in horizontal lateral plug cementing and cementing in deviated wellbores, or generally under conditions where it is difficult to control settling of a cement slurry.

These drawbacks are especially marked when cementing with slurries having a relatively high water content, for example scavenger cements containing large amounts of mix water, and extended low-density slurries with high water content are used.

Accordingly, a need remains for materials and methods that reduce cement fluid loss, e.g., generation of free water. There further remains a need for materials and methods that inhibit particle segregation in cement slurries, thereby reducing dropping of cement particles in the wellbore during plug cementing. In particular, a need remains for materials and methods that can both bind free water and control particle segregation during placement of a cement plug in wellbores.

### BRIEF DESCRIPTION

A cement slurry for use in a wellbore includes an aqueous cement slurry; and a preformed synthetic polymer swellable in the aqueous cement slurry.

A method of plug cementing a wellbore includes injecting into the wellbore a combination comprising the preformed synthetic polymer herein and the cement slurry, and setting the cement.

### DETAILED DESCRIPTION

A detailed description of one or more embodiments is presented herein by way of exemplification and not limitation.

An improved method for plug cementing a well uses a cement slurry combined with a water-swellable, preformed synthetic polymer. It has been discovered by the inventor hereof that use of the polymer allows improved stability, placement, and setting of a cement plug. Without being bound by theory, it is believed that the preformed synthetic polymer utilizes a novel particle packing mode to create a slurry that functions differently than current systems. Absorption of water causes the preformed synthetic polymer to swell, and in some embodiments, agglomerate to a hydrated pack of swelled polymer. Swelling of the polymer thus absorbs excess water in the slurry. This feature is especially beneficial in high annular pressure wellbore applications, where the high pressure can cause the cement in the slurry to dehydrate. Such dehydration is generally undesirable and can render the slurry unpumpable. Thus, in an advantageous feature, the compositions and method using the preformed synthetic polymer aids the pumpability of a cement slurry until it is set. In a still further advantageous feature, use of the preformed synthetic polymer inhibits segregation of cement particles, and their tendency to ultimately drop in the wellbore. This capability is particularly important in horizontal, lateral, or deviated wellbores. The foregoing characteristics are especially advantageous where difficult-to-control slurries, such as scavenger cement systems and extended low-density slurries with a relatively high water content, are used. In another advantageous feature, the fluids are stable, especially at the higher temperatures as they exist at the bottom of the wellbore. Use of the compositions herein accordingly reduce cement set-up times and prevent or minimize the risk of catastrophic failure of cement plug set-up. As such, the compositions advantageously improve the overall quality of plug cementing operations in the wellbore.

The cement slurry includes the swellable, preformed polymer, a hydraulic cement, and an aqueous carrier. The swellable preformed polymer can be included in the cement slurry as part of the mixing water in the slurry, or as a dry additive placed into the blended cement formulation. In an embodiment, the swellable, preformed synthetic polymer is present in an amount of about 0.1 to about 200 pounds per thousand gallons, preferably about 0.5 to about 150 pounds per thousand gallons, more preferably about 1 to about 75 pounds per thousand gallons, relative to the cement slurry. Still more preferably, the preformed synthetic polymer is present in an amount of about 5 to about 60 pounds per thousand gallons, preferably about 10 to about 50 pounds per thousand gallons of the cement slurry.

Because the swellable, preformed polymer is present in a cement slurry, the polymer is selected to be stable at a high pH. For example, the polymer is stable at a pH of greater than about 7, for example a pH greater than about 9, specifically a pH of about 10 to about 14, a pH of about 10 to about 13, a pH of about 11 to about 13, or a pH of about 11 to about 12.

The polymer can be present in the carrier fluid of the cement slurry in any form, including particulate. In an embodiment, the polymer particles are swelled polymer particles. Swelling of the polymer particles can be the result of water absorption by the particles. The swelled polymer particles can agglomerate to a hydrated pack including swelled polymer particles. In an embodiment, the cement slurry comprises a carrier fluid and a hydrated pack of swelled polymer particles comprising the preformed synthetic polymer.

The shape of the polymer particles before hydration or after swelling (after addition to the carrier fluid of the cement) is not critical, and can be regular or irregular, for example spherical, ovoid, polyhedral, or fibrous, stranded, or braided. In an embodiment, the polymer particles are in the form of beads having an approximately spherical shape. The particles can further have pores or spaces between the polymer chains that admits entrance of a fluid or other particles therein. The shape, size, size distribution, and concentration of the polymer particles in the carrier fluid should be effective to reduce free water and segregation of cement particles, and provide efficient displacement of the drilling fluids. For example, unswelled particles can have an average largest diameter of about 150 to about 1,000 micrometers, preferably about 150 to about 800 micrometers. The unswelled polymer particles (e.g. dry particles) are in general swellable. Swelling leads to an increase in average largest diameter of the particles. This particle swellability can be about 1 to about 10 times, or about 1 to about 15 times, about 1.5 to about 10 times, based on average largest diameter of a swelled polymer particle relative to average largest diameter of the same particle without swelling. In a non-limiting example, a dry polymer particle having an average largest diameter of about 100 micrometer can swell to a swelled polymer particle with an average largest diameter of about 1,000 micrometers.

In some embodiments, at least about 60%, preferably at least about 80%, more preferably at least about 95% of the swelled polymer particles in the cement slurry can have an average largest diameter of about 0.01 to about 100,000 micrometers, preferably about 0.1 to about 50,000 micrometers, or about 1 to about 10,000 micrometers more preferably about 100 to about 50,000 micrometers, about 500 to about 12,000 micrometers, or about 1,000 to about 8,000 micrometers. In other embodiments, at least about 95% of the polymer particles in the cement slurry can have an average largest diameter of about 100 to about 15,000 micrometers, more preferably about 500 to about 12,000 micrometers. At least about 90% of the polymer particles can have an average largest diameter of about 1 to about 10,000 micrometers, preferably about 100 to about 15,000 micrometers, more preferably about 500 to about 10,000 micrometers. At least about 75% of the polymer particles can have an average largest diameter of about 100 to about 15,000 micrometers, preferably about 500 to about 12,000 micrometers, preferably about 1,000 to about 10,000 micrometers. At least about 50% of the polymer particles can have an average largest diameter of about 500 to about 12,000 micrometers, preferably about 1,000 to about 10,000 micrometers, preferably about 1,000 to about 8,000 micrometers. At least about 30% of the polymer particles can have an average largest diameter of about 1,000 to about 10,000 micrometers, preferably about 1,000 to about 8,000 micrometers, more preferably about 1,500 to about 7,000 micrometers.

The preformed synthetic polymer can be a superabsorbent polymer (SAP), which as used herein is a crosslinked, neutral, neutralized or partially neutralized polymer that is capable of absorbing large amounts of aqueous liquids, such as water, brine, acid, or base, with swelling and the formation of a gel or viscous material, and that retains the absorbed fluid under a certain pressure or temperature. The superabsorbent polymer can have internal crosslinks, surface crosslinks, or a combination comprising at least one of the foregoing. Superabsorbent polymer particles are particles of superabsorbent polymers or superabsorbent polymer compositions. The acronym SAP may be used in place of superabsorbent polymer, superabsorbent polymer composition, and particles or fibers (and the like) herein.

The SAP comprises a hydrophilic network that retains large amounts of aqueous liquid relative to the weight of the SAP (e.g., in a dry state, the SAP absorbs and retains a weight amount of water equal to or greater than its own weight). In some embodiments, water is absorbed up to 500 times by weight, up to 400 times by weight, up to 300 times by weight, preferably up to 200 times by weight, even more preferably up to 100 times by weight, more preferably up to 50 times by weight of the synthetic polymer.

Non-limiting examples of such SAPs are poly(hydroxyC₁₋₈ alkyl (meth)acrylate)s such as (2-hydroxyethyl acrylate), poly(meth)acrylamide, poly(vinyl pyrrolidine), poly(vinyl acetate), and the like. The foregoing are inclusive of copolymers, for example copolymers of (meth)acrylamide with maleic anhydride, vinyl acetate, ethylene oxide, ethylene glycol, or acrylonitrile, or a combination comprising at least one of the foregoing. A combination of different polymers can be used.

The preformed synthetic polymers are polymerized from nonionic, anionic, cationic monomers, or a combination comprising at least one of the foregoing. Polymerization can be via free-radical polymerization, solution polymerization, gel polymerization, emulsion polymerization, dispersion polymerization, or suspension polymerization. Moreover, polymerization can be performed in an aqueous phase, in inverse emulsion, or in inverse suspension.

Examples of nonionic monomers for preparing the preformed synthetic polymers include (meth)acrylamide, alkyl-substituted (meth)acrylamides, aminoalkyl-substituted (meth)acrylamides, alkyliminoalkyl-substituted (meth)acrylamides, vinyl alcohol, vinyl acetate, allyl alcohol, C₁₋₈ alkyl (meth)acrylates, hydroxyC₁₋₈ alkyl (meth)acrylates such as hydroxyethyl (meth)acrylate, N-vinylformamide, N-vinylacetamide, and (meth)acrylonitrile. As used herein, “poly((meth)acrylamide)s” includes polymer comprising units derived from (meth)acrylamide, alkyl-substituted (meth)acrylamides such as N—C₁₋₈ alkyl (meth)acrylamides and N,N-di(C₁₋₈ alkyl) (meth)acrylamides, aminoalkyl-substituted (meth)acrylamides such as N,N-di(amino(C₁₋₈ alkyl))-substituted (meth)acrylamides, and (N,N-dialkylamino)alkyl-substituted (meth)acrylamides such as (N,N-di(C₁₋₈ alkyl)amino)(C₁₋₈ alkyl) (meth)acrylamides. Specific examples of the foregoing monomers include methacrylamide, N-methyl acrylamide, N-methyl methacrylamide, N,N-dimethyl acrylamide, N-ethyl acrylamide, N,N-diethyl acrylamide, N-cyclohexyl acrylamide, N-benzyl acrylamide, N,N-dimethylaminopropyl acrylamide, N,N-dimethylaminoethyl acrylamide, N-tert-butyl acrylamide, or a combination comprising at least one of the foregoing can be used. In an embodiment, the poly((meth)acrylamide) is a copolymer of methacrylamide with maleic anhydride, vinyl acetate, ethylene oxide, ethylene glycol, or acrylonitrile, or a combination comprising at least one of the foregoing.

Examples of anionic monomers include ethylenically-unsaturated anionic monomers having acidic groups, for example, a carboxylic group, a sulfonic group, a phosphonic group, a salt thereof, the corresponding anhydride or acyl halide, or a combination comprising at least one of the foregoing acidic groups. For example, the anionic monomer can be (meth)acrylic acid, ethacrylic acid, maleic acid, maleic anhydride, fumaric acid, itaconic acid, α-chloroacrylic acid, β-cyanoacrylic acid, β-methylacrylic acid, α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, citraconic acid, mesaconic acid, glutaconic acid, aconitic acid, 2-acrylamido-2-methylpropanesulfonic acid, allyl sulfonic acid, vinyl sulfonic acid, allyl phosphonic acid, vinyl phosphonic acid, or a combination comprising at least one of the foregoing can be used.

Examples of cationic monomers include (N,N-di(C₁₋₈alkylamino)(C₁₋₈alkyl) (meth)acrylates (e.g., N,N-dimethylaminoethyl acrylate and N,N-dimethylaminoethyl methacrylate), (wherein the amino group is quaternized to, e.g., a methyl chloride quaternary form), diallyldimethyl ammonium chloride, or any of the foregoing alkyl-substituted (meth)acrylamides and dialkylaminoalkyl-substituted (meth)acrylamides, such as (N,N-di(C₁₋₈alkyl)amino)C₁₋₈alkyl acrylamide, and the quaternary forms thereof such as acrylamidopropyl trimethyl ammonium chloride.

In an embodiment, the preformed synthetic polymer is amphoteric, containing both cationic substituents and anionic substituents. The cationic substituents and anionic substituents occur in various stoichiometric proportions, for example, a ratio of about 1:1, or one monomer can be present in a greater stoichiometric amount than the other monomer. Representative amphoteric polymers include terpolymers of nonionic monomers, anionic monomers and cationic monomers.

The preformed synthetic polymer can include a plurality of crosslinks among the polymer chains of the polymer. The crosslinks can be covalent and result from crosslinking the polymer chains using a crosslinker. The crosslinker can be an ethylenically-unsaturated monomer that contains, for example, two sites of ethylenic unsaturation (i.e., two ethylenically unsaturated double bonds), an ethylenically unsaturated double bond and a functional group that is reactive toward a functional group (e.g., an amide group) of the polymer chains of the polymer, or several functional groups that are reactive toward functional groups of the polymer chains of the polymer. The degree of crosslinking can be selected so as to control the amount of swelling of the polymer. For example, the degree of crosslinking can be used to control the amount of fluid absorption or the volume expansion of the polymer.

Exemplary crosslinkers include a diacrylamide or methacrylamide of a diamine such as a diacrylamide of piperazine; an acrylate or methacrylate ester of a di, tri, tetrahydroxy compound including ethyleneglycol diacrylate, polyethyleneglycol diacrylate, trimethylopropane trimethacrylate, ethoxylated trimethylol triacrylate, ethoxylated pentaerythritol tetracrylate, and the like; a divinyl or diallyl compound separated by an azo group such as a diallylamide of 2,2′-azobis(isobutyric acid) or a vinyl or allyl ester of a di or tri functional acid. Additional crosslinkers include water-soluble diacrylates such as poly(ethylene glycol) diacrylate (e.g., PEG 200 diacrylate) or PEG 400 diacrylate and polyfunctional vinyl derivatives of a polyalcohol such as ethoxylated (9-20) trimethylol triacrylate. Further examples of the crosslinker include aliphatic unsaturated amides, such as methylenebisacrylamide or ethylenebisacrylamide; aliphatic esters of polyols or alkoxylated polyols with ethylenically unsaturated acids, such as di(meth)acrylates or tri(meth)acrylates of butanediol, ethylene glycol, polyglycols, trimethylolpropane; di- and triacrylate esters of trimethylolpropane (which is oxyalkylated (such as ethoxylated) with an alkylene oxide such ethylene oxide); acrylate and methacrylate esters of glycerol or pentaerythritol; acrylate and methacrylate esters of glycerol and pentaerythritol oxyethylated with, e.g., ethylene oxide; allyl compounds (such as allyl(meth)acrylate, alkoxylated allyl(meth)acrylate reacted with, e.g., ethylene oxide, triallyl cyanurate, triallyl isocyanurate, maleic acid diallyl ester, poly-allyl esters, tetraallyloxyethane, triallylamine, tetraallylethylenediamine, diols, polyols, hydroxy allyl or acrylate compounds and allyl esters of phosphoric acid or phosphorous acid); or monomers that are capable of crosslinking, such as N-methylol compounds of unsaturated amides, such as of methacrylamide or acrylamide, and the ethers derived therefrom. A combination of the crosslinkers also can be employed.

When the preformed synthetic polymer is in the form of a particle, the particle can includes surface crosslink external to the interior of the particle. The surface crosslinks can result from addition of a surface crosslinker to the superabsorbent polymer particle and subsequent heat treatment. The surface crosslinks can increase the crosslink density of the particle near its surface with respect to the crosslink density of the interior of the particle. Surface crosslinkers can also provide the particle with a chemical property that the superabsorbent polymer did not have before surface crosslinking, and can control the chemical properties of the particle, for example, hydrophobicity, hydrophilicity, and adhesiveness of the sup erabsorbent polymer to other materials, for example, minerals (e.g., silicates) or other chemicals, for example, petroleum compounds (e.g., hydrocarbons, asphaltene, and the like).

Surface crosslinkers have at least two functional groups that are reactive with a group of the polymer chains, for example, any of the above crosslinkers, or crosslinkers having reactive functional groups such as an acid (including carboxylic, sulfonic, and phosphoric acids and the corresponding anions), an amide, an alcohol, an amine, or an aldehyde. Exemplary surface crosslinkers include polyols, polyamines, polyaminoalcohols, and alkylene carbonates, such as ethylene glycol, diethylene glycol, triethylene glycol, polyethylene glycol, glycerol, polyglycerol, propylene glycol, diethanolamine, triethanolamine, polypropylene glycol, block copolymers of ethylene oxide and propylene oxide, sorbitan fatty acid esters, ethoxylated sorbitan fatty acid esters, trimethylolpropane, ethoxylated trimethylolpropane, pentaerythritol, ethoxylated pentaerythritol, polyvinyl alcohol, sorbitol, ethylene carbonate, propylene carbonate, and combinations comprising at least one of the foregoing.

Additional surface crosslinkers include borate, titanate, zirconate, aluminate, chromate, or a combination comprising at least one of the foregoing. Boron crosslinkers include boric acid, sodium tetraborate, encapsulated borates, and the like. Borate crosslinkers can be used with buffers and pH control agents including sodium hydroxide, magnesium oxide, sodium sesquicarbonate, and sodium carbonate, amines (such as hydroxyalkyl amines, anilines, pyridines, pyrimidines, quinolines, pyrrolidines, and carboxylates such as acetates and oxalates), delay agents including sorbitol, aldehydes, sodium gluconate, and the like. Zirconium crosslinkers, e.g., zirconium lactates (e.g., sodium zirconium lactate), triethanolamines, 2,2′-iminodiethanol, or a combination comprising at least one of the foregoing can be used. Titanates crosslinkers can include, for example, lactates, triethanolamines, and the like.

The preformed synthetic polymer can include repeat units comprising an acrylate, an acrylamide, a vinylpyrrolidone, a vinyl ester (e.g., a vinyl acetate), a vinyl alcohol, a derivative thereof, or a combination comprising at least one of the foregoing. According to an embodiment, the preformed synthetic polymer can comprise polyacrylamide having crosslinks derived from polyethylene glycol diacrylate. In some embodiments, the superabsorbent polymer comprises polyacrylic acid, wherein the crosslinks are derived from a vinyl ester oligomer. In another embodiment, the superabsorbent polymer is a poly(acrylic acid) partial sodium salt-graft-poly(ethylene glycol), which is commercially available from Sigma Aldrich.

In addition to the preformed synthetic polymer, the polymer particles can further comprise a swellable natural polymer, e.g., a natural polysaccharide such as guar, carrageenan, starch, cellulose, xanthan gum, agar, pectin, alginic acid, tragacanth gum, pluran, gellan gum, tamarind seed gum, cardlan, gum arabic, glucomannan, chitin, chitosan, hyaluronic acid, and the like. The natural polysaccharides, when included in the particles, can aid in the hydration of the synthetic polymer. Alternatively, or in addition, the natural polymer can function as a friction reducer. Thus, the natural polymer can be included as a component of the cement slurry, that is, added separately from the synthetic particles. The weight ratio of preformed synthetic polymer to natural polymer, e.g., guar gum or carrageen can be about 99:1 to about 80:20, for example about 97:3 to about 85:15, preferably about 95:5 to about 90:10.

In an embodiment, the natural polymer is a guar gum or carrageenan as disclosed, for example, in Japanese Patent Application No. P2003-154262A. The guar gum can be a natural guar gum or an enzyme treated guar gum obtained by treating natural guar gum with galactosidase, mannosidase, or another enzyme. The guar gum can further be a galactomannan derivative prepared by treating natural guar gum with chemicals to introduce carboxyl groups, hydroxyl alkyl groups, sulfate groups, phosphate groups, and the like. Carrageenan is an ionic linear polysaccharide that includes repeating galactose units that individually can be sulfated or unsulfated. Specific carrageenan types include kappa, iota, lambda, and the like. In some embodiments, a mixture of carrageenan types is used. In a specific embodiment, a carrageenan or a carrageenan-like material that forms a gel is used. In addition to natural carrageenan, suitable carrageenans include enzyme-treated substances of natural carrageenan or derivatized carrageenan, e.g., those prepared by treating natural carrageenan (e.g., with a chemical) to introduce a functional group (e.g., a carboxyl group, hydroxyl alkyl group, sulfate group, phosphate group, and the like).

The cement slurry further comprises an aqueous carrier fluid. The aqueous carrier fluid water is present in the cement slurries in an amount of about 10% to about 60% by weight, more preferably in an amount of about 20% to about 40% by weight, based on the total weight of the cement slurry. The aqueous carrier fluid can be fresh water, brine (including seawater), an aqueous base, or a combination comprising at least one of the foregoing. It will be appreciated that other polar liquids such as alcohols and glycols, alone or together with water, can be used in the carrier fluid.

The brine can be, for example, seawater, produced water, completion brine, or a combination comprising at least one of the foregoing. The properties of the brine can depend on the identity and components of the brine. Seawater, for example, can contain numerous constituents including sulfate, bromine, and trace metals, beyond typical halide-containing salts. Produced water can be water extracted from a production reservoir (e.g., hydrocarbon reservoir) or produced from an underground reservoir source of fresh water or brackish water. Produced water can also be referred to as reservoir brine and contain components including barium, strontium, and heavy metals. In addition to naturally occurring brines (e.g., seawater and produced water), completion brine can be synthesized from fresh water by addition of various salts for example, KCl, NaCl, ZnCl₂, MgCl₂, or CaCl₂ to increase the density of the brine, such as 10.6 pounds per gallon of CaCl₂ brine. Completion brines typically provide a hydrostatic pressure optimized to counter the reservoir pressures downhole. The above brines can be modified to include one or more additional salts. The additional salts included in the brine can be NaCl, KCl, NaBr, MgCl₂, CaCl₂, CaBr₂, ZnBr₂, NH₄Cl, sodium formate, cesium formate, and combinations comprising at least one of the foregoing. The NaCl salt can be present in the brine in an amount of about 0.5 to about 25 weight percent (wt. %), specifically about 1 to about 15 wt. %, and more specifically about 3 to about 10 wt %, based on the weight of the fluid.

The hydraulic cement of the cement slurry can be any cementitious material that sets and hardens by reaction with water, and is suitable for forming a set cement downhole, including mortars and concretes. Suitable hydraulic cements, including mortars and concretes, include those typically employed in a wellbore environment, for example those comprising calcium, aluminum, silicon, oxygen, and/or sulfur. Such hydraulic cements include, but are not limited to, Portland cements, pozzolan cements, gypsum cements, high alumina content cements, silica cements, and high alkalinity cements, or combinations of these. Portland cements are particularly useful. In some embodiments, the Portland cements that are suited for use are classified as Class A, B, C, G, and H cements according to American Petroleum Institute, API Specification for Materials and Testing for Well Cements, and ASTM Portland cements classified as Type I, II, III, IV, and V. The cements herein also can include encompass various concretes by the further addition of aggregates, such as a coarse aggregate made of gravel or crushed rocks such as chert, quartzite, granite, and/or a fine aggregate such as sand or crushed sand. Aggregate can be added in an amount of about 10% to about 70% by weight of the hydraulic cement, and more particularly about 20% to about 40% by weight.

The hydraulic cement component can be present in the slurry in an amount of about 50 to about 95 wt. % of the weight of the slurry, preferably about 60 to about 90 wt. % of the weight of the slurry, more preferably about 65 to about 85 wt. %, based on the total slurry weight.

The cement slurries can further comprise other components known for use in cementing, for example a setting accelerator to reduce setting time, a setting retardant to extend setting time, a fluid loss control agent, an extender to lower density, a foaming agent to reduce density, a weighting agent to increase density, a dispersant to reduce viscosity, other fluid loss control agents, thixotropic agents, a bridging agent or lost circulation material (e.g., gilsonite or cellophane flakes), silicate materials such as sand, silica flour, fumed silica, act to strengthen cement as well as protect from strength retrogression effects at temperatures above 230° F., clay stabilizers, or a combination comprising at least one of the foregoing. These additive components are selected to avoid imparting unfavorable characteristics to the cement slurries, and to avoid damaging the wellbore or subterranean formation. Each additive can be present in amounts known generally to those of skill in the art.

Setting accelerators included compounds such as triethanolamines, calcium chloride, potassium chloride, sodium chloride, sodium formate, sodium nitrate, and other alkali and alkaline earth metal halides, formates, nitrates, and sulfates.

Setting retardants include compounds such as such as hydroxycarboxylic acids and their salts, such as sodium tartrate, sodium citrate, sodium gluconate, sodium itaconate, tartaric acid, citric acid, and gluconic acid, lignosulfonates, saccharides, polysaccharides, organophosphates such as C₂₋₁₂ alkylene phosphonic acids, salts such as sodium chloride, and oxides of zinc and lead, and the like.

Extenders include low density aggregates as described above, clays such as hydrous aluminum silicates (e.g., bentonite (85% mineral clay smectite), pozzolan (finely ground pumice of fly ash), diatomaceous earth, silica, e.g., a quartz and condensed silica fumed silica, expanded Pearlite, gilsonite, powdered coal, and the like.

The aqueous carrier fluid of the slurry can be foamed with a liquid hydrocarbon or a gas or liquefied gas such as nitrogen, or air. The fluid can further be foamed by inclusion of a non-gaseous foaming agent. The non-gaseous foaming agent can be amphoteric, cationic, or anionic. Suitable amphoteric foaming agents include alkyl betaines, alkyl sultaines, and alkyl carboxylates. Suitable anionic foaming agents can include alkyl ether sulfates, ethoxylated ether sulfates, phosphate esters, alkyl ether phosphates, ethoxylated alcohol phosphate esters, alkyl sulfates, and alpha olefin sulfonates. Suitable cationic foaming agents can include alkyl quaternary ammonium salts, alkyl benzyl quaternary ammonium salts, and alkyl amido amine quaternary ammonium salts. A foam system is mainly used in low pressure or water sensitive formations. A mixture of foaming and foam stabilizing dispersants can be used. Generally, the mixture can be included in the cement compositions in an amount of about 1% to about 5% by volume of water in the cement slurry.

Weighting agents are high-specific gravity and finely divided solid materials used to increase density, for example silica flour, fly ash, calcium carbonate, barite, hematite, ilemite, siderite, and the like.

Examples of suitable dispersants include but are not limited to naphthalene sulfonate formaldehyde condensates, acetone formaldehyde sulfite condensates, and glucan delta lactone derivatives. Other dispersants can also be used depending on the application of interest.

Fluid loss control agents additional to the synthetic swellable polymer can be present, for example a latex, latex copolymers, nonionic, water-soluble synthetic polymers and copolymers, such as guar gums and their derivatives, poly(ethyleneimine), cellulose derivatives, and polystyrene sulfonate.

Clay stabilizers prevent a clay from swelling downhole upon contact with the water or applied fracturing pressure and can be, for example, a quaternary amine, a brine (e.g., KCl brine), choline chloride, tetramethyl ammonium chloride, or the like. Clay stabilizers also include various salts such as NaCl, CaCl₂, and KCl, which also act at low concentrations to generally accelerate the set time associated with a cement slurry.

The various properties of the swellable, preformed polymer and the cement slurry can be varied and can be adjusted according to well control and compatibility parameters of the particular drilling fluid with which it is associated. The cement slurry can be used to form downhole components, including various casings, seals, plugs, packings, liners, and the like. In an embodiment the component is a plug, including a temporary cement plug, permanent cement plug, or a whipstock cement plug. The whipstock plug can be used to kick off from a vertical wellbore when a directional change in drilling is desired. The cement slurries can be used in vertical, horizontal, or deviated wellbores.

In general, in the methods herein, the preformed synthetic polymer is used to reduce the amount of free water, particle segregation, or both during cementing in a wellbore, in particular to during plug cementing. The preformed synthetic polymer can be premixed or is injected into the wellbore without mixing, e.g., injected “on the fly” where the components are combined as polymer is being injected downhole. Similarly, the cement slurry can be premixed or is injected without mixing, e.g., injected “on the fly” where the components, for example the cement particles, fluid or water, are combined as the slurry is being injected downhole. The order of addition can be varied and the time of injecting each is the same or different.

A pumpable or pourable aqueous cement slurry can be formed by any suitable method. In an exemplary embodiment, a slurry or mixture comprising the preformed synthetic polymer, the hydraulic cement and water or the aqueous carrier is combined using conventional cement mixing equipment. The aqueous cement slurry can then be injected, e.g., pumped and placed by various conventional cement pumps and tools to any desired location within the wellbore to fill any desired shape form. Once the aqueous cement slurry has been placed and assumed the shape form of the desired downhole article, the slurry is allowed to set and form a permanent shape of the base cement article, for example a cement plug.

The method is particular useful for cementing a wellbore, which includes injecting, generally pumping, into the wellbore the cement slurry containing the synthetic polymer at a pressure sufficient to displace a drilling fluid, for example a drilling mud, a cement spacer, or the like, optionally with a “lead slurry” or a “tail slurry”. The cement slurry can be introduced between a penetrable/rupturable bottom plug and a solid top plug. Once placed, the cement slurry is allowed to harden, and in some embodiments, forms a cement plug in the wellbore annulus, which prevents the flow of reservoir fluids between two or more permeable geologic formations that exist with unequal reservoir pressures. Usually, the slurry hardens by hydration and gelation of the cement. As is known by those of skill in the art, a high degree of variability exists in the above description of well cementation (e.g., multiple bottom plugs, graduated fluid densities, etc.), and can be effected using preformed synthetic polymers described herein.

Use of the cement slurries provides a number of benefits. The cement slurries are stable at high wellbore temperatures, for example up to about 350° F. In some embodiments, the cement slurries are stable at about 80 to about 350° F., or about 80 to about 250° F. The cement slurries are compatible with drilling fluids commonly used in wells.

The methods and compositions further have the advantages of reducing the amount of free water, movement of free water, and segregation of cement particles in a wellbore. When compared to otherwise identical methods except for the use of the preformed synthetic polymers, the reduction in free water can be at least about 1%, for example about 1 to about 50%, or about 20 to about 80%, or about 30 to about 90%, or about 40 to about 95%, or about 50 to about 100%. The methods and compositions further have the advantages of improved cementing, by reducing the movement of particles or water.

The above compositions and methods are especially useful in horizontal or deviated wellbores, or with scavenger cement slurry, and low-density cement slurries, which tend to have a higher water content. While the density of a scavenger or other low-density cement slurry can vary widely depending on downhole conditions, such densities can include about 5 to about 12 pounds per gallon when foamed. When unfoamed the density of a scavenger or low-density cement slurry can vary with such densities between about 9 up to about 15 pounds per gallon, or about 10 to about 14 pounds per gallons, or about 11 up to about 13 pounds per gallon. Of course, the cement slurries can also be higher density, for example about 15 to about 22 pounds per gallon.

All ranges disclosed herein are inclusive of the endpoints, and the endpoints are independently combinable with each other. The ranges are continuous and thus contain every value and subset comprising at least one of the foregoing in the range. As used herein, “combination” is inclusive of blends, mixtures, alloys, reaction products, and the like. The term “(meth)acryl” is inclusive of both acryl and methacryl. As used herein, “a combination comprising at least one of the foregoing” refers to a combination comprising at least one of the named constituents, components, compounds, or elements, optionally with a like component, compound, or element not named. The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” It should further be noted that the terms “first,” “second,” “primary,” “secondary,” and the like herein do not denote any order, quantity, or importance, but rather are used to distinguish one element from another. Embodiments herein can be used independently or can be combined.

All references are incorporated herein by reference.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A cement slurry for use in a wellbore, comprising
an aqueous cement slurry; and
a preformed synthetic polymer swellable in the aqueous cement slurry.

2. The cement slurry of claim 1, wherein the preformed synthetic polymer is stable at a basic pH.

3. The cement slurry of claim 1, wherein the preformed synthetic polymer is stable up to about 350° F.

4. The cement slurry of claim 1, wherein the preformed synthetic polymer comprises poly(hydroxyC₁₋₈ alkyl (meth)acrylate), poly(C₁₋₈ alkyl (meth)acrylate), poly(meth)acrylamide, poly(vinyl pyrrolidine), poly(vinyl acetate), or a combination comprising at least one of the foregoing polymers,

5. The cement slurry of claim 1, wherein the preformed synthetic polymer comprises
a homopolymer of (meth)acrylamide or a copolymer of (meth)acrylamide with maleic anhydride, vinyl acetate, ethylene oxide, ethylene glycol, acrylonitrile, or a combination comprising at least one of the foregoing;
poly(acrylamide) having crosslinks derived from polyethylene glycol diacrylate;
poly(acrylic acid) having crosslinks are derived from a vinyl ester oligomer; or
a poly(acrylic acid) partial sodium salt-graft-poly(ethylene glycol).

6. The cement slurry of claim 1, wherein the preformed synthetic polymer is present in the form of particles comprising the polymer.

7. The cement slurry of claim 1, wherein the particles are swelled and at least about 50% of the polymer particles have an average largest diameter of about 500 to about 12,000 micrometers.

8. The cement slurry of claim 1, wherein the preformed synthetic polymer is present in a concentration of about 0.1 to about 200 pounds per thousand gallons of the cement slurry.

9. The cement slurry of claim 1, wherein the cement slurry comprises a scavenger cement slurry, an extended low-density cement slurry or a dehydrating cement slurry.

10. The cement slurry of claim 1, comprising cement solids in an amount of about 50 to about 95 wt. % based on the total slurry weight.

11. A method of cementing a wellbore, the method comprising
injecting into the wellbore a combination comprising the preformed synthetic polymer and the aqueous cement slurry of claim 1; and
setting the cement slurry.

12. The method of claim 11, wherein the wellbore is a horizontal, lateral or deviated wellbore.

13. The method of claim 11, comprising absorbing water in the aqueous cement slurry up to about 500 times by weight, preferably up to about 200 times by weight, more preferably up to about 100 times by weight, based on the initial weight of synthetic polymer.

14. The method of claim 11, wherein the cement slurry remains pumpable at wellbore conditions until setting.

15. The method of claim 11, comprising increasing water absorption in the cement slurry compared to the same slurry without the polymer, preferably wherein the water absorption is at least about 1% greater than in the same slurry without the polymer.
